(19) United States
(12) Patent Application Publication
(10) Pub. No.: US 2024/0332667 A1
(43) Pub. Date: Oct. 3, 2024

(54) BATTERY AND ELECTRIC APPARATUS

(71) Applicant: Ningde Amperex Technology Limited, Ningde (CN)

(72) Inventor: Zhanglin XU, Ningde (CN)

(73) Assignee: Ningde Amperex Technology Limited, Ningde (CN)

(21) Appl. No.: 18/619,311

(22) Filed: Mar. 28, 2024

(30) Foreign Application Priority Data
Mar. 30, 2023 (CN) 202310324755.6

(51) Int. Cl. H01M 10/653; C09J 7/30; C09J 11/04; C09J 123/12; C09K 5/02; H01M 10/0587; H01M 10/613; H01M 10/647; H01M 10/651; H01M 10/654; H01M 50/105

(52) U.S. Cl. CPC H01M 10/653; C09J 7/30; C09J 11/04; C09J 123/12; C09K 5/02; H01M 10/0587; H01M 10/613; H01M 10/647; H01M 10/651; H01M 10/654; H01M 50/105; C09J 2203/33; C09J 2400/16; C09J 2423/10

(57) ABSTRACT

A battery, including an adhesive, where the adhesive is provided between a packaging bag and the battery cell, and the adhesive is adhered to an outer surface of the battery cell. The adhesive includes an adhesive layer, where the adhesive layer includes an adhesive material and a heat-absorbing material. When the temperature of the battery cell is 130° C., an adhesion force between the adhesive and the outer surface of the battery cell is m, and m satisfies m≥3 N. At room temperature (25° C.), the adhesive can be fixed to the outer surface of the battery cell. When the temperature of the battery cell rises, the adhesive can still be adhered to the outer surface of the battery cell, reducing the temperature of the battery cell and increasing the critical temperature for thermal runaway of the battery cell.

### CROSS-REFERENCE TO RELATED APPLICATION

This application claims priority to the Chinese Patent Application Serial No. 202310324755.6, filed on Mar. 30, 2023, the content of which is incorporated herein by reference in its entirety.

### TECHNICAL FIELD

This application relates to the field of battery technologies, and in particular, to a battery and an electric apparatus using such battery.

### BACKGROUND

In practical application, batteries may undergo extreme thermal abuse. Under external heat exposure, a battery cell experiences a temperature rise to a certain level, triggering self-heating and further elevating the temperature of the battery cell. This can impact the use of the battery and may lead to safety incidents such as battery cell ignition when the temperature of the battery cell reaches a thermal runaway temperature of the battery cell.

### SUMMARY

Some embodiments of the application provide a battery and an electric apparatus, so as to solve the problem of low heat resistance performance of the battery.

According to a first aspect, an embodiment of this application provides a battery, where the battery includes a packaging bag, a battery cell provided in the packaging bag, and an adhesive. The adhesive is provided between the packaging bag and the battery cell, and the adhesive is adhered to an outer surface of the battery cell. The adhesive includes an adhesive layer, where the adhesive layer includes an adhesive material and a heat-absorbing material, the heat-absorbing material being used to absorb heat from the battery cell when a temperature of the battery cell is greater than or equal to a preset temperature T1. When the temperature of the battery cell is 130° C., an adhesion force between the adhesive and the outer surface of the battery cell is m, m satisfying m≥3 N.

In some example embodiments, m satisfies 9 N≥m≥5 N.

In some example embodiments, based on a mass of the adhesive layer, a mass percentage of the heat-absorbing material is A, A satisfying 45%≤A≤90%.

In some example embodiments, A satisfies 60%≤A≤80%.

In some example embodiments, the heat-absorbing material includes at least one of a solid-liquid phase change heat-absorbing material, a solid-gas phase change heat-absorbing material, a solid-liquid-gas phase change heat-absorbing material, or a thermal decomposition heat-absorbing material.

In some example embodiments, the solid-liquid phase change heat-absorbing material, the solid-gas phase change heat-absorbing material, and the solid-liquid-gas phase change heat-absorbing material are at least one of tin-bismuth alloy, oxalic acid, malonate, glucose, erythritol, mannitol, sodium nitrate, polyethylene, acetanilide, or stearic acid; and the thermal decomposition heat-absorbing material includes at least one of barium carbonate, calcium carbonate, sodium bicarbonate, calcium bicarbonate, ammonium chloride, ammonium nitrate, ammonium bicarbonate, calcium chloride hexahydrate, magnesium nitrate hexahydrate, or sodium sulfate decahydrate.

In some example embodiments, the preset temperature T1 is a heat-absorbing start point temperature S1 of the heat-absorbing material, S1 satisfying 100° C.≤S1≤140° C. A heat-absorbing peak temperature S2 of the heat-absorbing material satisfies 120° C.≤S2≤150° C. a heat-absorbing end point temperature S3 of the heat-absorbing material satisfies 130° C.≤S3≤170° C.

In some example embodiments, a particle size of the heat-absorbing material is R1, R1 satisfying 5 μm≤R1≤25 μm.

In some example embodiments, a thickness of the adhesive layer is D, D satisfying 20 μm≤D≤100 μm.

In some example embodiments, the adhesive material includes at least one of polypropylene, polyethylene, styrene-butadiene rubber, or synthetic rubber.

In some example embodiments, when the temperature of the battery cell is 25° C., an adhesion force between the adhesive and the outer surface of the battery cell is n, n satisfying 3 N≤n−m≤10 N.

In some example embodiments, the adhesive is adhered to an inner surface of the packaging bag.

In some example embodiments, the battery cell is formed by stacking and winding a positive electrode plate, a separator, and a negative electrode plate. The battery cell includes a winding tail end, and the adhesive is adhered to the winding tail end to form a tail adhesive.

In some example embodiments, the heat-absorbing material fills in gaps of the adhesive material, and the adhesive material is used to be adhered to the outer surface of the battery cell and an inner surface of the packaging bag.

In some example embodiments, the adhesive layer includes at least two adhesive glue layers and at least one heat-absorbing layer, where the adhesive glue layer includes the adhesive material, and the heat-absorbing layer includes the heat-absorbing material. The adhesive glue layer and the heat-absorbing layer are alternately stacked, one of the outer adhesive glue layers is used to be connected to the outer surface of the battery cell, and another one of the outer adhesive glue layers is used to be adhered to the inner surface of the packaging bag.

In some example embodiments, the adhesive further includes a substrate layer. The substrate layer is stacked with the adhesive layer, and the adhesive layer is provided on at least one surface of the substrate layer.

In some example embodiments, the substrate layer includes one of polypropylene film, polyethylene film, and glass fiber film.

In some example embodiments, the outer surface of the battery cell includes an end wall surface perpendicular to a length direction of the battery cell and a peripheral wall connected to the end wall surface at an angle, and the adhesive is adhered to at least one of the peripheral wall or the end wall surface.

In some example embodiments, the peripheral wall includes a side wall surface perpendicular to a thickness direction of the battery, the adhesive is adhered to the side wall surface with an adhesion area of C1, and an area of the side wall surface of the battery cell is C2, C1 and C2 satisfying 0.1≤C1/C2≤1.

In some example embodiments, the adhesive is adhered to the end wall surface and extends and is adhered to a part of the peripheral wall.

The battery and electric apparatus according to some embodiments of this application include an adhesive, where the adhesive includes an adhesive material and a heat-absorbing material. At room temperature (25° C.), the adhesive is fixed to the outer surface of the battery cell. When the temperature of the battery cell rises, the adhesive can still be adhered to the outer surface of the battery cell to fix the heat-absorbing material to the battery cell for absorbing the heat from the battery cell, improving heat absorbing efficiency. The adhesive material being adhered to the heat-absorbing material can also enable the heat-absorbing material to be embedded or enter the layer structure where the adhesive material is located, thus reducing the thickness of the adhesive. When the adhesive is used in a battery, the adhesive occupies a small space of the battery, which is conducive to increasing an ED value of the battery.

### BRIEF DESCRIPTION OF DRAWINGS

To describe the technical solutions in some embodiments of this application or in the prior art more clearly, the following briefly describes the accompanying drawings required for describing these embodiments or the prior art. Apparently, the accompanying drawings in the following description show only some embodiments of this application, and persons of skill in the art may derive other drawings from these accompanying drawings without creative efforts.

FIG. 1 is a schematic side view of an adhesive provided on a side wall surface of a battery cell according to an embodiment of this application;

FIG. 2 is a schematic diagram of an adhesive material filling in gaps of a heat-absorbing material according to an embodiment of this application;

FIG. 3 is a schematic diagram of a heat-absorbing layer provided between two adhesive glue layers according to an embodiment of this application;

FIG. 4 is a schematic diagram of two adhesive layers provided on two opposite sides of a substrate layer according to an embodiment of this application;

FIG. 5 is a schematic diagram of two adhesive layers provided on two opposite sides of a substrate layer according to another embodiment of this application;

FIG. 6 is a schematic front view of an adhesive provided on a side wall surface of a battery cell according to an embodiment of this application;

FIG. 7 is a schematic side view of an adhesive provided on an end wall surface of a battery cell according to an embodiment of this application; and

FIG. 8 is a schematic front view of an adhesive provided on an end wall surface of a battery cell according to an embodiment of this application.

### REFERENCE SIGNS

100. adhesive; 110. adhesive layer; 111. adhesive material; 112. heat-absorbing material; 120. substrate layer;
200. battery cell; 210. side wall surface; 220. end wall surface;
310. positive electrode tab; 320. negative electrode tab; A. length direction; B. thickness direction; and C. width direction.

### DETAILED DESCRIPTION

To make the objectives, technical solutions, and advantages of this application more comprehensible, the following describes this application in detail with reference to the accompanying drawings and some embodiments. It should be understood that some specific embodiments described herein are merely used to explain this application but are not intended to limit this application.

The inventor has found that in the related art, with the provision of a phase change heat-absorbing material on an outer surface of a battery cell or a surface of an electrode plate of a battery, the heat resistance performance of the battery can be improved. However, if the phase change heat-absorbing material is used alone, on one hand, the phase change heat-absorbing material expands when it absorbs heat at a high temperature, which increases the thickness of the battery cell and causes more ED loss; on the other hand, the expansion of the phase change heat-absorbing material placed on the surface of the battery cell at a high temperature will lead to a poor fitting between the phase change heat-absorbing material and the battery cell, greatly reducing its heat-absorbing effect and as a result, the heat of the battery cell cannot be absorbed effectively. In addition, the inventor has also found that when adhesive paper is provided on the outer surface of the battery cell and the adhesive paper is used to adhere the battery cell to an inner surface of the packaging bag, the adhesive paper only plays a role of fixing the battery cell and has no function of absorbing the heat from the battery cell. In view of this, some embodiments of this application provide an adhesive used for a battery and a battery. With the provision of a heat-absorbing material in the adhesive layer used for adhering the battery cell and the packaging bag, the heat resistance performance of the battery can be improved effectively, and the ED of the battery is also increased.

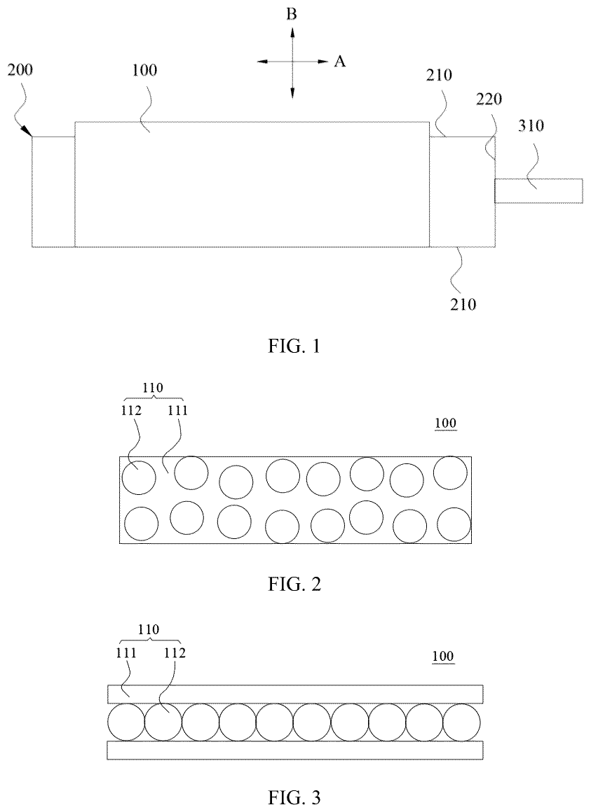

An embodiment of this application provides an adhesive 100 used for a battery. As shown in FIG. 1, the battery includes a packaging bag (not shown in the figure) and a battery cell 200 provided in the packaging bag. The adhesive 100 is provided between the packaging bag and the battery cell 200, and the adhesive 100 is adhered to an outer surface of the battery cell 200, so as to improve the structural stability of the battery cell 200.

The adhesive 100 includes an adhesive layer 110. As shown in FIG. 2, the adhesive layer 110 includes an adhesive material 111 and a heat-absorbing material 112. The adhesive material 111 is adhered to the heat-absorbing material 112 to fix a position of the heat-absorbing material 112, and the adhesive material 111 is further used to be adhered to the outer surface of the battery cell 200 to fix a position of the adhesive 100 relative to the battery cell 200. In addition, when the heat-absorbing material 112 undergoes a phase change or decomposition and absorbs heat from the battery cell 200, the adhesive material 111 can still be adhered to the outer surface of the battery cell 200 to fix the position of the adhesive 100.

An adhesion force between the adhesive 100 and the outer surface of the battery cell 200 is m, m satisfying m≥3 N when a temperature of the battery cell 200 is 130° C., so that when the temperature of the battery cell 200 rises, the adhesive 100 can still have a good adhesion force to be adhered to the outer surface of the battery cell 200 and act on the battery cell 200, thus reducing the degree of deformation or displacement of the battery cell 200 when the battery cell 200 is overheated. Under a condition that m satisfies 9 N≥m≥5 N, when the temperature of the battery cell 200 becomes higher, the adhesive 100 can still have a good adhesion force to be adhered to the outer surface of the battery cell 200 and act on the battery cell 200. In this case, the adhesive 100 provides a better effect on cooling the battery cell 200.

In this application, the adhesive 100 includes the adhesive material 111 and the heat-absorbing material 112. At room temperature (25° C.), the adhesive 100 can be fixed on the outer surface of the battery cell 200. When the environmental temperature of the battery cell 200 rises, or when the temperature of the battery cell 200 rises because the battery cell starts to generate heat in a high-temperature environment, the adhesive 100 can still be adhered to the outer surface of the battery cell 200 to fix the heat-absorbing material 112 to the battery cell 200 to absorb the heat from the battery cell 200, thereby improving the heat absorbing efficiency. If the heat-absorbing material 112 is not fixed on the outer surface of the battery cell 200, the heat-absorbing material 112 is separated from the battery cell 200 when the temperature of the battery cell rises, which reduces the efficiency of the heat-absorbing material 112 in absorbing the heat from the battery cell 200. As a result, the battery cell temperature cannot be reduced effectively and may easily lead to safety problems. The adhesive material 111 adhering to the heat-absorbing material 112 can also enable the heat-absorbing material 112 to embed or enter the layer structure where the adhesive material 111 is located, thus reducing the thickness of the adhesive 100. When the adhesive 100 is used in a battery, the battery space occupied by the adhesive 100 is reduced, which is conducive to increasing the ED value of the battery.

In some example embodiments, based on a mass of the adhesive layer 110, a mass percentage of the heat-absorbing material 112 is A, A satisfying 45%≤A≤90%. Within this mass range, the heat-absorbing material 112 can effectively absorb the heat from the battery cell 200. When the mass percentage A of the heat-absorbing material 112 is less than 45%, the amount of the heat-absorbing material 112 is too small to exert an effective heat-absorbing function. This results in a weak cooling effect on the battery cell 200. When the amount of heat-absorbing material exceeds 90%, the insufficient quantity of adhesive material makes it challenging for the adhesive 100 to be stably adhered to the outer surface of the battery cell 200 after the temperature of the battery cell rises, so the adhesive cannot play an effective adhering function, leading to the separation of the heat-absorbing material from the battery cell and reducing the heat-absorbing effect.

Preferably, A satisfies 60%≤A≤80%. Within this range, the heat-absorbing material 112 has a good cooling effect on the battery cell 200, and the ratio of the heat-absorbing material 112 to the adhesive material 111 is appropriate. When the heat-absorbing material 112 undergoes phase change or decomposition, the adhesive material 111 can still be stably adhered to the outer surface of the battery cell 200.

In some example embodiments, the heat-absorbing material 112 includes at least one of a solid-liquid phase change heat-absorbing material, a solid-gas phase change heat-absorbing material, a solid-liquid-gas phase change heat-absorbing material, or a thermal decomposition heat-absorbing material. For example, the heat-absorbing material 112 includes a thermal decomposition heat-absorbing material and one of a solid-liquid phase change heat-absorbing material, a solid-gas phase change heat-absorbing material, and a solid-liquid-gas phase change heat-absorbing material; or the heat-absorbing material 112 includes a solid-liquid-gas phase change heat-absorbing material and one of a solid-liquid phase change heat-absorbing material and a solid-gas phase change heat-absorbing material.

In some example embodiments, the solid-liquid phase change heat-absorbing material, the solid-gas phase change heat-absorbing material, and the solid-liquid-gas phase change heat-absorbing material are at least one of tin-bismuth alloy, oxalic acid, malonate, glucose, erythritol, mannitol, sodium nitrate, polyethylene, acetanilide, or stearic acid.

In some example embodiments, the thermal decomposition heat-absorbing material includes at least one of barium carbonate, calcium carbonate, sodium bicarbonate, calcium bicarbonate, ammonium chloride, ammonium nitrate, ammonium bicarbonate, calcium chloride hexahydrate, magnesium nitrate hexahydrate, or sodium sulfate decahydrate.

In some example embodiments, the heat-absorbing material 112 is used to absorb the heat from the battery cell 200 when the temperature of the battery cell 200 is greater than or equal to a preset temperature T1. The preset temperature T1 is a heat-absorbing start point temperature S1 of the heat-absorbing material 112, and S1 satisfies 100° C.≤S1≤140° C. A heat-absorbing peak temperature S2 of the heat-absorbing material 112 satisfies 120° C.≤S2≤150° C.; A heat-absorbing end point temperature S3 of the heat-absorbing material 112 satisfies 130° C.≤S3≤170° C. Within the ranges of the heat-absorbing start point temperature S1, the heat-absorbing peak temperature S2, and the heat-absorbing end point temperature S3 of the heat-absorbing material 112, the heat-absorbing material 112 can undergo phase change or decomposition to absorb the heat of the battery cell 200. The heat-absorbing material 112 has a relatively wide heat absorption range, which can improve the thermal environment of the battery cell 200 and effectively reduce the temperature of the battery cell 200.

Optionally, at a temperature below the heat-absorbing start point temperature S1, the form of the heat-absorbing material 112 remains unchanged. Correspondingly, the status of connection of the heat-absorbing material 112 to the adhesive material 111 remains unchanged, and the connection of the adhesive 100 to the outer surface of the battery cell 200 has good adhering stability. At a temperature higher than the heat-absorbing end point temperature S3, the form of the heat-absorbing material 112 changes, and the heat absorbing efficiency is low or the heat-absorbing material 112 no longer has the heat-absorbing function.

In some example embodiments, the heat-absorbing efficiency of the heat-absorbing material 112 to the battery cell 200 at temperature S1 is x1, the heat-absorbing efficiency of the heat-absorbing material 112 to the battery cell 200 at temperature S2 is x2, and the heat-absorbing efficiency of the heat-absorbing material 112 to the battery cell 200 at temperature S3 is x3, where x2≥x1, and x2≥x3. During selection of the heat-absorbing material 112, a heat-absorbing material 112 with a wide range of heat-absorbing peak temperature S2 can be selected for application in the adhesive 100 to improve the heat absorbing efficiency.

It can be understood that the temperature rise of the battery cell 200 is a process of gradual increase in the temperature. During the temperature rise process, the temperature of the battery cell 200 needs to rise from the heat-absorbing start point temperature S1 to the heat-absorbing peak temperature S2. Due to the morphological changes of the heat-absorbing material 112 occurring during heat absorption, the status of adhering between the heat-absorbing material 112 and the adhesive material 111 also changes. The adhesion force m between the adhesive 100 provided in this application and the outer surface of the battery cell 200 is greater or equal to 3 N at 130° C. This allows the heat-absorbing material 112 to efficiently absorb the heat from the battery cell 200 and at the same time, the adhesive 100 can be stably adhered to the outer surface of the battery cell 200, further improving the heat absorbing efficiency of the heat-absorbing material 112 for rapid cooling of the battery cell 200.

In some example embodiments, a particle size of the heat-absorbing material 112 is R1, R1 satisfying 5 μm≤R1≤25 μm. The particle size of the heat-absorbing material 112 within this range is appropriate. When the heat-absorbing material 112 undergoes phase change or decomposition, the adhesive 100 can still maintain good structural stability. Moreover, within a limited area, the distribution density of the heat-absorbing material 112 is greater, allowing for more efficient absorption of heat from the battery cell 200. When the particle size of the heat-absorbing material 112 is greater than 25 μm, the specific surface area of the heat-absorbing material 112 becomes too small. Consequently, the contact area between the heat-absorbing material 112 and the adhesive material 111 and the contact area between the heat-absorbing material 112 and the battery cell 200 are too small, leading to a decrease in the heat-absorbing efficiency of the heat-absorbing material 112.

In some example embodiments, the adhesive material 111 is a thermosetting adhesive material. For example, liquid or gel-like thermosetting adhesive material and heat-absorbing material 112 are provided together on the outer surface of the battery cell 200, followed by heat treatment to solidify the thermosetting adhesive material. This process enables the thermosetting adhesive material to be adhered and fixed to the outer surface of the battery cell 200. Furthermore, the heat-absorbing start point temperature S1 of the heat-absorbing material 112 is greater than the curing temperature of the thermosetting adhesive material, preventing the heat-absorbing material 112 from undergoing phase change or decomposition when the adhesive material 111 is heat-cured and adhered to the outer surface of the battery cell 200. This allows the heat-absorbing material 112 to be more effectively used for absorbing the heat from the battery cell 200. Additionally, the adhesive material 111 has heat-resistant characteristics. For example, the melting point temperature of the adhesive material 111 is higher than the heat-absorbing peak temperature S2 of the heat-absorbing material 112, so that when the heat-absorbing material 112 undergoes phase change or decomposition, the form of the adhesive material 111 remains stable. Consequently, the adhesive 100 does not easily move relative to the battery cell 200.

In some example embodiments, the adhesive material 111 includes at least one of polypropylene, polyethylene, styrene-butadiene rubber, or synthetic rubber.

In some example embodiments, when the temperature of the battery cell 200 is 25° C., an adhesion force between the adhesive 100 and the outer surface of the battery cell 200 is n, n satisfying 3 N≤n−m≤10 N. With the increase in temperature, the heat-absorbing material undergoes decomposition or phase change to absorb heat, which may affect the adhesion force of the adhesive material 111 to the battery cell 200. When n and m satisfy the condition 3 N≤n−m≤10 N, the adhesive 100 does not lose its adhesion force to the battery cell 200 at higher temperatures. Consequently, the heat-absorbing material 112 can still be fixed to the outer surface of the battery cell 200 at higher temperatures to absorb heat.

In some example embodiments, the adhesive 100 is further used to be adhered to an inner surface of the packaging bag. Fixing the position of the battery cell 200 relative to the packaging bag with the adhesive 100 improves the drop resistance performance of the electrochemical apparatus. Additionally, an extra structure for fixing the battery cell 200 to the packaging bag needs not to be provided anymore. Application of the adhesive 100 to the battery can effectively increase the ED of the battery.

The battery cell 200 is formed by stacking and winding a positive electrode plate, a separator, and a negative electrode plate. The battery cell 200 includes a winding tail end, and the adhesive 100 is adhered to the winding tail end to serve as a tail adhesive of the battery cell, ensuring a tight and non-loose wound structure of the battery cell 200, preventing the winding tail end from becoming loose and freely moving and absorbing the heat from the battery cell. This further reduces the loss of energy density of the battery cell. For example, the tail adhesive is adhered to the outer surface of the winding tail end. When the adhesive 100 forms a tail adhesive, the adhesive 100 can also be adhered to the inner surface of the packaging bag.

In some example embodiments, as shown in FIG. 2, the heat-absorbing material 112 fills in gaps of the adhesive material. For example, the heat-absorbing material 112 and the adhesive material are mixed to uniformity, which helps the heat-absorbing material 112 to uniformly absorb the heat from the battery cell 200. When the adhesive material 111 is adhered to the outer surface of the battery cell 200, the heat-absorbing material 112 can also come into contact with the outer surface of the battery cell 200 to improve the heat-absorbing efficiency.

In some example embodiments, as shown in FIG. 3, the adhesive 100 includes at least two adhesive glue layers and at least one heat-absorbing layer, where the adhesive glue layer includes the adhesive material 111, and the heat-absorbing layer includes the heat-absorbing material 112. The adhesive glue layer and the heat-absorbing layer are alternately stacked, and one of the outer adhesive glue layers is used to be connected to the outer surface of the battery cell 200, and another one of the outer adhesive glue layers is used to be adhered to the inner surface of the packaging bag. At this point, the heat-absorbing layer sandwiched between the two adhesive layers 110 can effectively absorb the heat from the battery cell 200. Optionally, the thickness of the heat-absorbing layer is H, H satisfying 20 μm≤H≤100 μm, while the thickness of the adhesive layer 110 is D, D satisfying ⅛H≤D≤½H. An excessively thick adhesive layer may occupy too much internal space of the battery, affecting energy density; and an excessively thin adhesive layer may not provide effective adhesion.

In some example embodiments, D satisfies 20 μm≤D≤100 μm. Within this thickness range, on one hand, the adhesive layer 110 can meet the requirements of absorbing heat from the battery cell 200 and adhering to and fixing the battery cell 200; on the other hand, this can prevent the situation of excessive thickness of the adhesive layer 110 reducing the ED value of the battery when the adhesive 100 is applied to the battery.

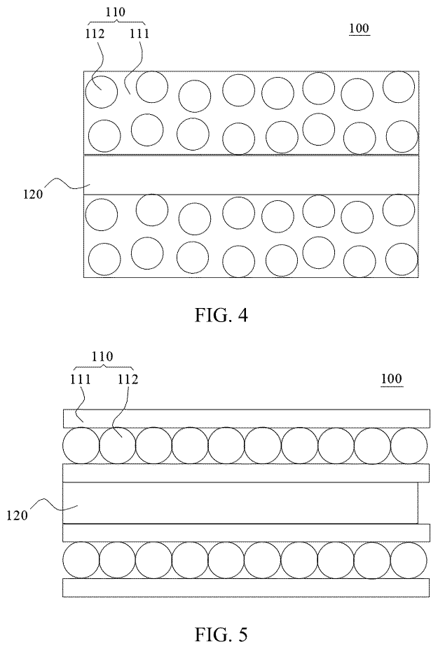

In some example embodiments, as shown in FIGS. 4 and 5, the adhesive 100 further includes a substrate layer 120, where the substrate layer 120 is stacked with the adhesive layer 110, and the adhesive layer 110 is provided on at least one surface of the substrate layer 120. The substrate layer 120 is used to bear the adhesive material 111 and the heat-absorbing material 112, which helps to enhance the stability of the adhesion of the adhesive 100 to the outer surface of the battery cell 200, preventing the adhesive layer 110 from being torn easily. For example, when the adhesive 100 is used as a tail adhesive, the adhesive 100 includes the substrate layer 120 and one adhesive layer 110, where the adhesive layer 110 is provided on one surface of the substrate layer 120 and is used to be adhered to the outer surface of the battery cell 200; or when the adhesive 100 is further used to be adhered to the inner surface of the packaging bag, the adhesive 100 includes the substrate layer 120 and two adhesive layers 110, where one adhesive layer 110 is provided on one surface of the substrate layer 120 and is adhered to the outer surface of the battery cell 200, while the other adhesive layer 110 is provided on another surface of the substrate layer 120 and is adhered to the inner surface of the packaging bag, effectively reducing the movement of the battery cell inside the packaging bag.

In some example embodiments, the substrate layer 120 includes one of polypropylene film, polyethylene film, and glass fiber film.

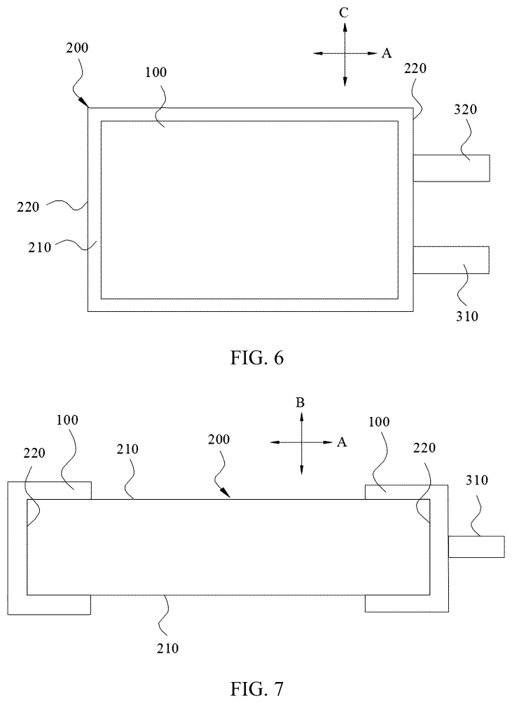

In some example embodiments, the outer surface of the battery cell 200 includes an end wall surface 220 perpendicular to a length direction A of the battery cell and a peripheral wall connected to the end wall surface 220 at an angle. Specifically, as shown in FIG. 6, the outer surface of the battery cell 200 includes two end wall surfaces 220 oppositely provided along the length direction A of the battery, and the peripheral wall is located between and connects the two end wall surfaces 220. The battery also includes a positive electrode tab 310 and a negative electrode tab 320. The positive electrode tab 310 is electrically connected to the positive electrode plate, and the negative electrode tab 320 is electrically connected to the negative electrode plate. Both the positive electrode tab 310 and the negative electrode tab 320 extend from the end wall surface 220 out of the battery cell 200. Optionally, as shown in FIG. 6, the positive electrode tab 310 and the negative electrode tab 320 are located at the same end wall surface 220. The adhesive 100 is adhered to at least one of the peripheral wall or the end wall surface 220.

In some example embodiments, the peripheral wall includes a side wall surface 210 perpendicular to a thickness direction B of the battery, and in the thickness direction B of the battery, the peripheral wall includes two oppositely provided side wall surfaces 210. Specifically, the battery cell 200, formed by stacking the positive electrode plate, the separator, and the negative electrode plate, includes one straight portion and two curved portions. The two curved portions are located at two ends of the straight portion along the width direction C of the battery. The side wall surface 210 is the surface of the straight portion, and the adhesive 100 is adhered to the side wall surface 210; alternatively, the adhesive 100 can be provided as adhering to a surface of a curved portion of the battery cell 200; alternatively, the adhesive 100 can be configured as adhering to a side wall surface 210 and extending from the side wall surface 210 to a surface of a curved portion and adhering to the surface of the curved portion.

Optionally, the adhesive 100 is adhered to one of the side wall surfaces 210 of the battery cell 200; alternatively, the adhesive 100 is adhered to both side wall surfaces 210 of the battery cell 200. The adhesive 100 is adhered to the side wall surface 210 with an adhesion area of C1, and an area of the side wall surface 210 of the battery cell 200 is C2, C1 and C2 satisfying 0.1≤C1/C2≤1. With this adhesion area, the battery cell 200 can be adhered and fixed to the inner surface of the packaging bag, allowing the heat-absorbing material 112 to efficiently absorb heat from the battery cell 200. The heat-absorbing effect of the adhesive 100 adhered to the outer surface of the battery cell 200 improves with the increase in the value of C1/C2. However, a larger adhesion area of the adhesive 100 also occupies more space, which may reduce the energy density of the electrochemical apparatus. Preferably, C1 and C2 satisfy: C1/C2≤0.5, and the adhesive 100 is adhered to one of the side wall surfaces 210 of the battery cell 200, improving the performance of cooling the battery cell without compromising the energy density of the battery cell.

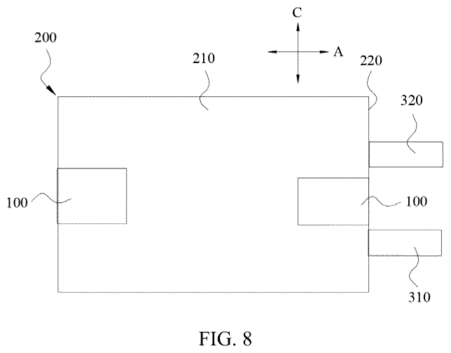

In some example embodiments, as shown in FIGS. 7 and 8, the adhesive 100 is adhered to the end wall surface 220. Further, the adhesive 100 extends from the end wall surface 220 and is adhered to a part of the peripheral wall, thus improving the adhering stability. When the positive electrode tab 310 and the negative electrode tab 320 extend out of the battery cell 200 from the same end wall surface 220, as shown in FIG. 8, the adhesive 100 adhered to the end wall surface 220 is provided between the positive electrode tab 310 and the negative electrode tab 320. This helps to fix all wound layers of the battery cell 200, improve the drop performance of the battery cell, and absorb the heat from the battery cell 200.

An embodiment of this application further provides a battery, where the battery includes a packaging bag, a battery cell 200, and the foregoing adhesive 100. The battery cell 200 includes a positive electrode plate, a negative electrode plate, and a separator. The positive electrode plate, the negative electrode plate, and the separator are stacked and wound in sequence to form the battery cell 200. The battery cell 200 is provided in the internal space of the packaging bag, and the adhesive 100 is adhered to the outer surface of the battery cell 200 and the inner surface of the packaging bag. The battery cell 200 is fixed to the inner surface of the packaging bag through the adhesive 100, and the heat-absorbing material 112 contained in the adhesive 100 can undergo phase change or decomposition to absorb the heat from the battery cell 200, conducive to lowering the temperature of the battery cell 200.

The battery further includes an electrolyte, where the electrolyte is provided in the internal space of the packaging bag and infiltrates the positive electrode plate, the separator, and the negative electrode plate. The electrolyte is not particularly limited in this application. The electrolyte includes a lithium salt and a non-aqueous solvent. Any lithium salt known in the art can be used, provided that the objectives of this application can be achieved. For example, the lithium salt may include at least one of LiTFSI, LiPF6, LiBF4, LiAsF6, LiClO4, LiB(C₆H₅)₄, LiCH₃SO₃, LiCF₃SO₃, LiN(SO₂CF₃)₂, LiC(SO₂CF₃)₃, or LiPO₂F₂. The non-aqueous solvent is not particularly limited in this embodiment of this application, provided that the objectives of this application can be achieved. For example, the non-aqueous solvent may include at least one of carbonate compound, carboxylate compound, ether compound, nitrile compound, or another organic solvent. The carbonate compound may include at least one of diethyl carbonate (DEC), dimethyl carbonate (DMC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), vinyl ethylene carbonate (VEC), fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate.

The positive electrode plate includes a positive electrode current collector and a positive electrode active material layer provided on a surface of the positive electrode current collector; and the negative electrode plate includes a negative electrode current collector and a negative electrode active material layer provided on a surface of the negative electrode current collector. Based on the stacking and winding order of the positive electrode plate, the separator, and the negative electrode plate, when the positive electrode plate is the outermost layer, the adhesive 100 is adhered to the surface of the positive electrode active material layer of the positive electrode plate; or when the negative electrode plate is the outermost layer, the adhesive 100 is adhered to the surface of the negative electrode active material layer of the negative electrode plate.

The positive electrode plate is not particularly limited in this application. The positive electrode active material layer includes the positive electrode active material. The positive electrode active material is not particularly limited in this embodiment of this application, provided that the objectives of this application can be achieved. For example, the positive electrode active material includes at least one of nickel cobalt manganese ternary material, nickel cobalt aluminum material, lithium iron phosphate, lithium cobalt oxide, lithium manganate, lithium iron manganese phosphate, or lithium titanate.

The positive electrode active material layer further includes a positive electrode conductive agent and/or a positive electrode binder. The positive electrode conductive agent is not particularly limited in this embodiment of this application, provided that the objectives of this application can be achieved. For example, the positive electrode conductive agent may include at least one of conductive carbon black, acetylene black, Ketjen black, lamellar graphite, graphene, carbon nanotube, or carbon fiber. The positive electrode binder is not particularly limited in this embodiment of this application, provided that the objectives of this application can be achieved. For example, the positive electrode binder includes at least one of polyvinylidene fluoride, vinylidene fluoride-hexafluoropropylene copolymer, polyacrylonitrile, polyacrylate, polyacrylic acid, polyacrylate, styrene-acrylate copolymer, styrene-butadiene copolymer, polyamide, sodium carboxymethylcellulose, polyvinyl acetate, polyvinylpyrrolidone, polyvinyl ether, polytetrafluoroethylene, polyhexafluoropropylene, or polymethylmethacrylate.

The positive electrode current collector is not particularly limited in this application. The positive electrode current collector may be any positive electrode current collector known in the art, for example, an aluminum foil, an aluminum alloy foil, or a composite current collector.

The negative electrode plate is not particularly limited in this application. The negative electrode active material layer includes the negative electrode active material. The negative electrode active material is not particularly limited in this application. The negative electrode active material may be any negative electrode active material in the prior art. The negative electrode active material includes at least one of graphite, hard carbon, soft carbon, silicon, silicon carbon, or silicon oxide.

The negative electrode active material layer may further include a negative conductive agent and/or a negative electrode binder. The negative electrode conductive agent is not particularly limited in this embodiment of this application, provided that the objectives of this application can be achieved. For example, the negative electrode conductive agent may include at least one of carbon black, acetylene black, Ketjen black, lamellar graphite, graphene, carbon nanotube, carbon fiber, or carbon nanowire. The negative electrode binder is not particularly limited in this embodiment of this application, provided that the objectives of this application can be achieved. For example, the negative electrode binder may include at least one of carboxymethyl cellulose (CMC), polyacrylic acid, a polyacrylic acid salt, polyacrylate, polyvinylpyrrolidone, polyaniline, polyimide, polyamideimide, silicone oil, styrene butadiene rubber, phenolic epoxy resin, polyester resin, polyurethane resin, or polyfluorene.

The negative electrode current collector is not particularly limited in this application. The negative electrode current collector may be any negative electrode current collector known in the art, for example, a copper foil, an aluminum foil, an aluminum alloy foil, or a composite current collector.

The outer package is not particularly limited in this embodiment of this application, provided that the objectives of this application can be achieved. For example, the external package may include an aluminum-plastic film outer package.

The following further describes this application in detail with reference to specific examples by taking a lithium-ion battery as an example.

### I. Test Method for Performance of Lithium-Ion Battery

### (1) Hot-Box Test Method for Lithium-Ion Battery

The lithium-ion battery was fully charged at a current of 0.5C. The fully charged lithium-ion battery was vertically suspended in a heating box, and the box was heated at a heating velocity of 5° C./min. After the furnace temperature was raised to a specified temperature, the temperature was kept for a certain time. During the whole process, a thermocouple was used to record the surface temperature of the battery cell 200 and whether ignition occurred.

### (2) Test of Phase Change Material Percentage in Adhesive Paper

The percentage of a phase change material in the phase change heat-absorbing adhesive paper can be tested through thermogravimetry (TG) and DSC.

### (3) Adhesion Force Test

The adhesion force m of the adhesive 100 to the outer surface of the battery cell 200 could be separately tested by using a normal temperature tensile machine and a high temperature tensile machine. The testing temperature of the normal temperature tensile machine was 10° C.-35° C., the tensile speed was 1 m/min, and the tensile angle was 180 degrees; and the testing temperature of the high temperature tensile machine was 100° C.-150° C., the tensile speed was 1 m/min, and the tensile angle was 180 degrees.

### II. Preparation of Lithium-Ion Battery

### 1. Preparation of Electrolyte

In a dry argon atmosphere glove box, propylene carbonate, ethylene carbonate, and diethyl carbonate were mixed at a mass ratio of 1:1:1 to obtain an organic solvent, and then a lithium salt LiPF₆ was added to the organic solvent for dissolving and mixing to uniformity, to obtain an electrolyte. A concentration of LiPF₆ in the electrolyte was 1 mol/L.

### 2. Preparation of Separator

Polyacrylate was applied on a surface of a porous polyethylene film (provided by Celgard) to obtain a separator, where the porous polyethylene film had a thickness of 7 μm and a pore size of 0.1 μm, the coating weight of the polyacrylate was 10±2 mg/5000 mm², and the coating thickness of the polyacrylate was 3±1 μm.

### 3. Preparation of Lithium-Ion Battery

The positive electrode plate, the separator, and the negative electrode plate were stacked in sequence, so that the separator was placed between the positive and negative electrode plates for isolation, and the stack was wound to obtain a battery cell 200. The battery cell 200 was put into an aluminum-plastic film packaging bag which was filled with the electrolyte after drying, followed by processes such as vacuum packaging, standing, formation, degassing, and cutting to obtain a lithium-ion battery. An upper limit voltage for formation was 4.45V, a formation temperature was 80° C., and a standing time in formation was 2 h.

### Example 1

Preparation of adhesive 100: The adhesive material 111 (liquid polypropylene) and the heat-absorbing material 112 (tin-bismuth alloy powder) were mixed to uniformity to obtain a liquid adhesive 100. The liquid adhesive 100 was sprayed on the two side wall surfaces 210 of the battery cell 200 by using a spraying device. The thickness of the liquid adhesive 100 was controlled to be 50 μm. Then, the battery cell 200 was put into a packaging bag and dried at 85° C., so that the adhesive 100 was adhered the battery cell 200 to the packaging bag. In this example, based on the mass of the adhesive layer, the mass percentage of the heat-absorbing material 112 (tin-bismuth alloy powder) was 45%.

The adhesive 100 in this example could adhere the battery cell 200 and the packaging bag together at room temperature, preventing the battery cell 200 from moving in the packaging bag. When the battery cell 200 was heated to 130° C., the adhesion force of the adhesive material 111 in the adhesive 100 to the battery cell 200 could still maintain at above 3 N. This allowed the adhesive 100 and the battery cell 200 to be fixed together, enhancing the heat conduction between the adhesive 100 and the battery cell 200, triggering the phase change heat absorption of the heat-absorbing material 112, thereby reducing the temperature of the battery cell 200, and preventing thermal runaway of the batter cell 200.

### Example 2

Difference from Example 1 includes: based on the mass of the adhesive layer, the mass percentage A of the heat-absorbing material 112 (Sn—Bi alloy powder) was 90%.

### Example 3

Difference from Example 1 includes: based on the mass of the adhesive layer, the mass percentage A of the heat-absorbing material 112 (Sn—Bi alloy powder) was 80%.

### Example 4

Difference from Example 1 includes: based on the mass of the adhesive layer, the mass percentage A of the heat-absorbing material 112 (Sn—Bi alloy powder) was 60%.

### Example 5

Difference from Example 1 includes: based on the mass of the adhesive layer, the mass percentage A of the heat-absorbing material 112 (Sn—Bi alloy powder) was 85%.

### Example 6

Difference from Example 1 includes: based on the mass of the adhesive layer, the mass percentage A of the heat-absorbing material 112 (Sn—Bi alloy powder) was 70%.

### Example 7

Difference from Example 1 includes: based on the mass of the adhesive layer, the mass percentage A of the heat-absorbing material 112 (Sn—Bi alloy powder) was 50%.

### Example 8

Difference from Example 1 includes: based on the mass of the adhesive layer, the mass percentage A of the heat-absorbing material 112 (Sn—Bi alloy powder) was 40%.

### Example 9

Difference from Example 1 includes: based on the mass of the adhesive layer, the mass percentage A of the heat-absorbing material 112 (Sn—Bi alloy powder) was 95%.

### Example 10

Difference from Example 3 includes: the heat-absorbing material 112 included malonate.

### Example 11

Difference from Example 3 includes: the heat-absorbing material 112 included magnesium nitrate hexahydrate.

### Example 12

Difference from Example 3 includes: the heat-absorbing material 112 included calcium bicarbonate.

### Example 13

Difference from Example 3 includes: the heat-absorbing material 112 included calcium bicarbonate and tin-bismuth alloy powder.

### Example 14

Difference from Example 3 includes: the adhesive 100 was adhered to two side wall surfaces 210 and an end wall surface 220 of the battery cell 200.

### Example 15

Difference from Embodiment 3 includes: the adhesive 100 was adhered to an end wall surface 220 of the battery cell 200.

### Example 16

Difference from Example 1 includes: the adhesive material 111 (liquid polypropylene) and paraffin were mixed to uniformity to obtain the adhesive. The adhesive was adhered to two side wall surfaces 210 of the battery cell 200, the thickness of the adhesive was controlled to be 50 μm, and then the battery cell 200 was put into a packaging bag. In this example, based on the mass of the adhesive, the mass percentage of the paraffin was 80%. The heat-absorbing start point temperature of paraffin wax is lower than 100° C. (60° C.).

In this example, when the battery cell 200 was subjected to a high temperature of 130° C., the paraffin could not effectively absorb the heat from the battery cell 200, resulting in a large temperature rise of the battery cell 200.

### Comparative Example 1

Difference from Example 1 includes: the battery cell was provided with no adhesive.

### Comparative Example 2

Difference from Example 3 includes: the adhesive 100 was not adhered to the outer surface of the battery cell 200.

In this comparative example, when the battery cell 200 was subjected to a high temperature of 130° C., the heat could be easily conducted into the adhesive 100 and the heat-absorbing material 112 could not effectively absorb the heat from the battery cell 200, resulting in a large temperature rise of the battery cell 200.

### Comparative Example 3

Difference from Example 3 includes: the adhesive 100 was adhered to the outer surface of the battery cell 200 and the adhesion force was 2 N.

In this comparative example, when the battery cell 200 was subjected to a high temperature of 130° C., the heat could not be relatively easily conducted into the adhesive 100 and the efficiency of heat absorption by the heat-absorbing material 112 from the battery cell 200 is low, resulting in a large temperature rise of the battery cell 200.

Related parameters of the foregoing examples and comparative examples are shown in Table 1.

TABLE 1

| | | | | | Mass | | | |
|---|---|---|---|---|---|---|---|---|
| | | | | | percentage | | | Maximum |
| | | S1 of | S3 of | | A of heat- | adhesion | adhesion | temperature |
| | | heat- | heat- | | absorbing | force n of | force m of | of battery |
| | Heat- | absorbing | absorbing | | material in | adhesive | adhesive | cell at |
| Design | absorbing | material | material | Position | adhesive | at 25° C. | at 130° C. | 130° C. |
| example | material | (° C.) | (° C.) | of adhesive | layer | (N) | (N) | (° C.) |
| Example 1 | Tin- | 135 | 140 | Side wall | 45% | 18 | 9 | 148 |
| | bismuth | | | surface | | | | |
| | alloy | | | | | | | |
| Example 2 | Tin- | 135 | 140 | Side wall | 90% | 12 | 4 | 140 |
| | bismuth | | | surface | | | | |
| | alloy | | | | | | | |
| Example 3 | Tin- | 135 | 140 | Side wall | 80% | 15 | 5 | 142 |
| | bismuth | | | surface | | | | |
| | alloy | | | | | | | |
| Example 4 | Tin- | 135 | 140 | Side wall | 60% | 17 | 7 | 145 |
| | bismuth | | | surface | | | | |
| | alloy | | | | | | | |
| Example 5 | Tin- | 135 | 140 | Side wall | 85% | 13 | 4 | 141 |
| | bismuth | | | surface | | | | |
| | alloy | | | | | | | |
| Example 6 | Tin- | 135 | 140 | Side wall | 70% | 16 | 6 | 144 |
| | bismuth | | | surface | | | | |
| | alloy | | | | | | | |
| Example 7 | Tin- | 135 | 140 | Side wall | 50% | 17.5 | 8 | 147 |
| | bismuth | | | surface | | | | |
| | alloy | | | | | | | |
| Example 8 | Tin- | 135 | 140 | Side wall | 40% | 18.5 | 10.5 | 149 |
| | bismuth | | | surface | | | | |
| | alloy | | | | | | | |
| Example 9 | Tin- | 135 | 140 | Side wall | 95% | 10 | 3 | 146 |
| | bismuth | | | surface | | | | |
| | alloy | | | | | | | |
| Example 10 | Malonate | 134 | 145 | Side wall | 80% | 15 | 5 | 145 |
| | | | | surface | | | | |
| Example 11 | Magnesium | 120 | 135 | Side wall | 80% | 15 | 5 | 141 |
| | nitrate | | | surface | | | | |
| | hexahydrate | | | | | | | |
| Example 12 | Calcium | 125 | 140 | Side wall | 80% | 15 | 5 | 143 |
| | bicarbonate | | | surface | | | | |
| Example 13 | Tin- | 125 | 140 | Side wall | 80% | 15 | 5 | 142.5 |
| | bismuth | | | surface | | | | |
| | alloy + | | | | | | | |
| | calcium | | | | | | | |
| | bicarbonate | | | | | | | |
| Example 14 | Tin- | 135 | 140 | Side wall | 80% | 15 | 5 | 139.5 |
| | bismuth | | | surface + | | | | |
| | alloy | | | end wall | | | | |
| | | | | surface | | | | |
| Example 15 | Tin- | 135 | 140 | End wall | 80% | 15 | 5 | 142 |
| | bismuth | | | surface | | | | |
| | alloy | | | | | | | |
| Example 16 | Paraffin | 60 | 100 | Side wall | 80% | 15 | 5 | 156 |
| | | | | surface | | | | |
| Comparative | None | / | / | / | 0% | 20 | 9 | 170 |
| Example 1 | | | | | | | | |
| Comparative | Tin- | 135 | 140 | Side wall | 80% | 0 | 0 | 158 |
| Example 2 | bismuth | | | surface | | | | |
| | alloy | | | | | | | |
| Comparative | Tin- | 135 | 140 | Side wall | 97% | 8 | 2 | 165 |
| Example 3 | bismuth | | | surface | | | | |
| | alloy | | | | | | | |

As can be seen from Examples 1 to 16 and Comparative Example 1, when the adhesive 100 is provided on the outer surface of the battery cell 200, where the adhesive 100 includes the adhesive material 111 and the heat-absorbing material 112, the temperature of the battery cell 200 can be effectively reduced at a high temperature.

As can be seen from Examples 1 to 15 and Example 16, the heat-absorbing material capable of phase change or decomposition in use, compared with a hot melt material, can better absorb heat from the battery cell 200, resulting in a more effective cooling effect on the battery cell 200.

As can be seen from Examples 1 to 9 and Comparative Example 2, at 130° C., the adhesion force m of the adhesive 100 to the outer surface of battery cell 200 is greater than 3 N and the heat-absorbing material 112 can be fixed on the outer surface of battery cell 200 to absorb heat from the battery cell 200, which can effectively reduce the temperature of the battery cell 200. Preferably, when the temperature of the battery cell 200 is 130° C., the adhesion force m of the adhesive 100 to the outer surface of the battery cell 200 satisfies 9 N≥m≥5 N, and the adhesive 100 has a better cooling effect on the battery cell 200.

As can be seen from Examples 1 to 9 and Comparative Example 3, at 130° C., the adhesion force m of adhesive 100 to the outer surface of battery cell 200 is greater than 3 N and the heat-absorbing material 112 can be fixed on the outer surface of battery cell 200 to absorb heat from battery cell 200, which can effectively reduce the temperature of battery cell 200. When m is less than 3 N, the heat cannot be effectively conducted to the adhesive 100, resulting in a low heat-absorbing efficiency.

As can be seen from Example 1 to Example 16, for battery cell temperature at room temperature and 130° C., when m and n satisfy 3 N≤n−m≤10 N, the adhesive has a good cooling effect on the battery cell.

As can be seen from Examples 1 to 9, based on the mass of the adhesive layer, when the mass percentage A of the heat-absorbing material 112 satisfies 45%≤A≤90%, the adhesion force of the adhesive 100 to the battery cell 200 is stable and the cooling effect is good. When A>90%, the adhesive material 111 is insufficient, and the expansion of the heat-absorbing material results in reduced adhesion force and reduced fit of the adhesive 100 to the battery cell 200, making it challenging to fix the heat-absorbing material 112 to the outer surface of the battery cell 200, leading to reduced heat-absorbing effect. When A<45%, insufficient heat-absorbing material 112 makes it difficult for the adhesive 100 to exert a heat-absorbing effect for a long time. Preferably, A satisfies 60%≤A≤80%, so that the ratio of the adhesive material 111 to the heat-absorbing material 112 is appropriate, maintaining excellent adhesion with the battery cell 200 and providing sufficient heat-absorbing material 112 for absorbing heat from the battery cell 200.

In the accompanying drawings of some embodiments, identical or similar reference signs correspond to identical or similar components. In the description of this application, it should be understood that if the azimuth or positional relationship indicated by the terms “upper”, “lower”, “left” and “right” is based on the azimuth or positional relationship shown in the attached drawings, it is only for the convenience of describing this application and simplifying the description, and it does not indicate or imply that the device or element referred to must have a specific orientation, be constructed and operated in a specific orientation. Therefore, the terms describing positional relationships in the accompanying drawings are only used for exemplary explanation and shall not be construed as any limitation on this patent. Persons of ordinary skill in the art can understand specific meanings of these terms as suitable to specific situations.

The foregoing descriptions are merely preferable embodiments of this application, but are not intended to limit this application. Any modification, equivalent replacement, or improvement made without departing from the spirit and principle of this application shall fall within the protection scope of this application.

What is claimed is:

1. A battery, comprising a packaging bag, a battery cell provided in the packaging bag, and an adhesive; wherein the adhesive is provided between the packaging bag and the battery cell, the adhesive is adhered to an outer surface of the battery cell;
the adhesive comprises an adhesive layer, wherein the adhesive layer comprises an adhesive material and a heat-absorbing material, the heat-absorbing material is configured to absorb heat from the battery cell when a temperature of the battery cell is greater than or equal to a preset temperature T1; and when the temperature of the battery cell is 130° C., an adhesion force between the adhesive and the outer surface of the battery cell is m, and m≥3 N.

2. The battery according to claim 1, wherein 9 N≥m≥5 N.

3. The battery according to claim 1, wherein based on a mass of the adhesive layer, a mass percentage of the heat-absorbing material is A, and 45%≤A≤90%.

4. The battery according to claim 3, wherein 60%≤A≤80%.

5. The battery according to claim 1, wherein the heat-absorbing material comprises at least one of a solid-liquid phase change heat-absorbing material, a solid-gas phase change heat-absorbing material, a solid-liquid-gas phase change heat-absorbing material, or a thermal decomposition heat-absorbing material.

6. The battery according to claim 5, wherein
the solid-liquid phase change heat-absorbing material, the solid-gas phase change heat-absorbing material, and the solid-liquid-gas phase change heat-absorbing material each independently are at least one of a tin-bismuth alloy, oxalic acid, malonate, glucose, erythritol, mannitol, sodium nitrate, polyethylene, acetanilide, or stearic acid; and
the thermal decomposition heat-absorbing material comprises at least one of barium carbonate, calcium carbonate, sodium bicarbonate, calcium bicarbonate, ammonium chloride, ammonium nitrate, ammonium bicarbonate, calcium chloride hexahydrate, magnesium nitrate hexahydrate, or sodium sulfate decahydrate.

7. The battery according to claim 5, wherein the preset temperature T1 is a heat-absorbing start point temperature S1 of the heat-absorbing material, and 100° C.≤S1≤140° C.;
a heat-absorbing peak temperature S2 of the heat-absorbing material satisfies 120° C.≤S2≤150° C.; and
a heat-absorbing end point temperature S3 of the heat-absorbing material satisfies 130° C.≤S3≤170° C.

8. The battery according to claim 1, wherein the adhesive satisfies at least one of the following conditions:
condition a: a particle size of the heat-absorbing material is R1, 5 μm≤R1≤25 μm; or
condition b: a thickness of the adhesive layer is D, 20 μm≤D≤100 μm.

9. The battery according to claim 1, wherein the adhesive material comprises at least one of polypropylene, polyethylene, styrene-butadiene rubber, or synthetic rubber.

10. The battery according to claim 1, wherein when the temperature of the battery cell is 25° C., an adhesion force between the adhesive and the outer surface of the battery cell is n, and 3 N≤n−m≤10 N.

11. The battery according to claim 1, wherein the adhesive is adhered to an inner surface of the packaging bag.

12. The battery according to claim 1, wherein the battery cell comprises a positive electrode plate, a separator, and a negative electrode plate; the positive electrode plate, the separator, and the negative electrode plate are stacked and wound together to form the battery cell; the battery cell comprises a winding tail end, and the adhesive is adhered to the winding tail end to form a tail adhesive.

13. The battery according to claim 1, wherein
the heat-absorbing material fills in gaps of the adhesive material, and the adhesive material is adhered to the outer surface of the battery cell and an inner surface of the packaging bag; or
the adhesive layer comprises at least two adhesive glue layers and at least one heat-absorbing layer, wherein the adhesive glue layer comprises the adhesive material, and the heat-absorbing layer comprises the heat-absorbing material; and the adhesive glue layer and the heat-absorbing layer are alternately stacked, and the heat-absorbing layer is located between the two adhesive glue layers.

14. The battery according to claim 1, wherein the adhesive further comprises
a substrate layer stacked with the adhesive layer, wherein the adhesive layer is provided on at least one surface of the substrate layer.

15. The battery according to claim 14, wherein the substrate layer comprises one of a polypropylene film, a polyethylene film, or a glass fiber film.

16. The battery according to claim 1, wherein the outer surface of the battery cell comprises an end wall surface perpendicular to a length direction of the battery cell and a peripheral wall connected to the end wall surface at an angle, and the adhesive is adhered to at least one of the peripheral wall or the end wall surface.

17. The battery according to claim 16, wherein
the peripheral wall comprises a side wall surface perpendicular to a thickness direction of the battery, the adhesive is adhered to the side wall surface with an adhesion area of C1, and an area of the side wall surface is C2, 0.1≤C1/C2≤1; or
the adhesive is adhered to the end wall surface and extends and is adhered to the peripheral wall.

18. The battery according to claim 11, wherein the battery cell comprises a positive electrode plate, a separator, and a negative electrode plate; the positive electrode plate, the separator, and the negative electrode plate are stacked and wound together to form the battery cell; the battery cell comprises a winding tail end, and the adhesive is adhered to the winding tail end to form a tail adhesive.

19. An electric apparatus, comprising the battery according to claim 1.

20. The electric apparatus according to claim 19, wherein based on a mass of the adhesive layer, a mass percentage of the heat-absorbing material is A, and 45%≤A≤90%.
